(19) United States
(12) Patent Application Publication
(10) Pub. No.: US 2026/0079093 A1
(43) Pub. Date: Mar. 19, 2026

(54) METHOD AND SYSTEM FOR DYNAMICALLY DETERMINING A TYPE OF PARTICLES EMITTED DURING AN INDUSTRIAL ACTIVITY IN A PHYSICAL MEDIUM

(71) Applicant: ELLONA, TOULOUSE (FR)

(72) Inventor: Ivan ROMANYTSIA, Toulouse (FR)

(73) Assignee: ELLONA, TOULOUSE (FR)

(21) Appl. No.: 18/834,719

(22) PCT Filed: Feb. 6, 2023
(86) PCT No.: PCT/EP2023/052824

§ 371 Date: Jan. 30, 2025

(30) Foreign Application Priority Data
Feb. 22, 2022 (FR) FR2201548

(51) Int. Cl. G01N 15/0205

(52) U.S. Cl. CPC G01N 15/0205

(57) ABSTRACT

A method for dynamically determining a type (Te) of particles (1) emitted during the operation of an industrial activity (2) in a physical medium (3), the method comprising: a step of measuring the sound (E1) of the industrial activity (2) in order to determine a common sound signature (Sc), a step of determining (E2), by means of a first database (4), a first list of types of particles (MI) from the common sound signature (Sc), a step of measuring the particle size (E3) of the particles (1) emitted in the physical medium (3) in order to determine a common particle size signature (Gc), a step of determining (E4), by means of a second database (5) a second list of types of particles (NI) from the common particle size signature (Gc), a step of determining (E7) the type (Te) of particles (1) by intersecting the lists of types of particles (MI, NI).

### TECHNICAL FIELD

The present invention relates to the field of particle identification during the implementation of an industrial activity in a physical medium.

Many industrial production activities generate airborne particles referred to as aerosols, the concentration of which must be monitored to protect the health of the operators. For example, sawdust, welding, drilling and sanding are examples of activities that produce aerosols, such as glass, wood and metal particles.

For monitoring purposes, air samples are taken and analyzed to determine the aerosol concentrations and assess the air quality. Analyzing such samples is costly and time-consuming. In addition, the fact that the samples are taken on an ad hoc basis means that regular monitoring is not possible.

It has also been known to install analysis equipment on the industrial production site or to equip operators to monitor the concentration of aerosols continuously. Such analysis equipment generally comprises a sensor, in particular an optical particle counter. Such a sensor allows to determine the quantity and the statistical distribution of the size of the aerosols, i.e., a particle size signature. Such a particle size signature may be compared with one or more predetermined tolerance thresholds in order to detect a potential danger to the operator.

In practice, an operator carries out several different activities and is therefore exposed to different types of particles, each with a different tolerance threshold. It is therefore necessary to identify the particles emitted so that they may be compared with a relevant tolerance threshold. This is because several different types of particle may have a similar particle size signatures, which does not allow to distinguish them reliably. A prior art analysis equipment therefore does not provide a satisfactory response to the need for air quality monitoring.

To eliminate this disadvantage, an obvious solution would be to provide a sensor for each type of particle or to ask the operator to enter the type of particle likely to be present and/or its tolerance threshold according to the activity he or she is carrying out, to allow a relevant measurement to be made. Such a solution is not feasible, given that the same operator may have to change activity very frequently, which is restrictive and liable to be forgotten.

The aim of the invention is to determine dynamically and reliably the type of particles emitted during an industrial activity in a physical medium. The invention applies in particular to airborne particles, but also to particles present in powders.

In the field of powder manufacture, such as on flour milling sites, it is necessary to control the quality of the powder, i.e., to determine the particle size profile of the flour grains in order to check the homogeneity of the powder. In practice, different types of flour are milled on the same site and comprise different acceptance thresholds, which means they need to be distinguishable.

### PRESENTATION OF THE INVENTION

The invention relates to a method for dynamically determining at least one type of particles, the particles being emitted during the implementation of an industrial activity in a physical medium, said method being implemented by means of at least:
a first database comprising a plurality of reference sound signatures, each being associated with a first list of particle types, each reference sound signature being characteristic of at least one industrial activity, and
a second database comprising a plurality of reference particle size signatures, each being associated with a second list of particle types, each reference particle size signature being characteristic of at least one particle type,
said method comprising:
   a step of measuring the sound of the industrial activity in the physical medium, so as to determine a current sound signature,
   a step of determining, by means of the first database, a first list of particle types from the current sound signature,
   a step of measuring the particle size of the particles emitted into the physical medium, so as to determine a current particle size signature,
   a step of determining, by means of the second database, a second list of particle types from the current particle size signature,
   a step of determining at least one type of particles by intersecting the first list of particle types and the second list of particle types.

The invention allows to identify a type of particle at its emission site dynamically, simply and reliably. The invention is of particular interest in monitoring air quality at industrial production sites so as to check that the particles emitted by an industrial activity do not exceed a predetermined acceptance threshold. The invention is also of particular interest in the quality control of a powder so as to check that its level of homogeneity is sufficient.

The invention is advantageously based on taking into account a sound signature of the particle emission activity, which is cross-referenced with a particle size signature to allow the type of particle to be identified. Advantageously, such a sound signature is easy to measure and discriminating. In particular, the sound signature allows to reliably distinguish between two types of particle with similar particle size signatures. This means that each time an operator changes activity, they benefit from an appropriate monitoring of the particles emitted, guaranteeing their health and safety.

According to an aspect of the invention, said method is also implemented by means of a threshold database comprising a plurality of types of particles, each being associated with an acceptance threshold, said method comprising:
a step of determining, by means of the threshold database, an acceptance threshold on the basis of the type of particles determined, and
a step of emitting an alarm if the current particle size signature exceeds the acceptance threshold.

Advantageously, the method is implemented directly on the particle emission site, without waiting, and in an automated manner, for example periodically. The method thus allows an autonomous monitoring of the level of particles in a given physical medium, alerting the user if a tolerance threshold is exceeded. An appropriate alarm may be emitted for each activity carried out by the operator.

According to one aspect of the invention, each reference sound signature of the first database comprises at least one frequency characteristic of the associated industrial activity, and preferably a sound spectrum characteristic of the associated industrial activity. Advantageously, each industrial activity has an associated characteristic sound spectrum that is sufficiently different from the others to allow it to be easily identified.

According to one aspect of the invention, the particle size measurement step is implemented by means of an optical particle counter. An optical particle counter provides an accurate and reliable measurement of the distribution of the sizes of the particles and their concentration.

According to one aspect of the invention, the determination step is implemented by determining from among the reference sound signatures of the first database which is closest to the current sound signature.

According to one aspect of the invention, the determination step is implemented by means of a statistical classification module, preferably of the support vector or neural network type.

According to an aspect of the invention, the method also comprises a preliminary step of training the statistical classification module from a plurality of training sound signatures, the statistical classification module being configured to determine the closest reference sound signature in the first database.

According to a preferred aspect, the determination step is implemented by determining which of the reference particle size signatures in the second database is closest to the current particle size signature.

According to a preferred aspect, the determination step is implemented by means of a statistical classification module, preferably of the support vector or neural network type.

In a preferred aspect, the method comprises a preliminary step of training the statistical classification module from a plurality of training particle size signatures, the statistical classification module being configured to determine the closest reference particle size signature in the second database.

According to an aspect of the invention, the method is also implemented by means of a third database comprising a plurality of reference physical signatures, each being associated with a third list of particle types, each reference physical signature being characteristic of the physical medium, said method comprising:
a step of measuring a current physical signature of the physical medium,
a step of determining, by means of the third database, a third list of particle types from the current physical signature,
the determination step being further implemented by intersection with the third list of particle types.

The method thus combines three different types of measurement to identify the type of particles, namely a measurement of the particle size of the particles, a measurement of the sound emitted by the industrial activity and a measurement of a parameter of the physical medium. This increases the accuracy and the reliability of the method.

According to one aspect of the invention, the current physical signature comprises one or more of the following elements: a temperature measurement, a humidity measurement and an odor measurement of the physical medium. Combined with the sound signature and the particle size signature, this physical signature allows to increase the accuracy and the reliability of the method,

According to a preferred aspect, the determining step is implemented by determining which of the reference physical signatures in the second database is closest to the current physical signature.

According to a preferred aspect, the determination step is implemented using a statistical classification module, preferably of the support vector or neural network type.

In a preferred aspect, the method comprises a preliminary step of training the statistical classification module from a plurality of training physical signatures, the statistical classification module being configured to determine the closest reference physical signature in the second database.

The invention also relates to a system for dynamically determining at least one type of particles implementing the method as described above, the particles being emitted during the implementation of an industrial activity in a physical medium, said system comprising at least:
a first database comprising a plurality of reference sound signatures, each being associated with a first list of particle types, each reference sound signature being characteristic of at least one industrial activity, and
a second database comprising a plurality of reference particle size signatures, each being associated with a second list of particle types, each reference particle size signature being characteristic of at least one particle type,
a first measuring member configured to measure a current sound signature of the industrial activity in the physical medium,
a second measuring member configured to measure a current particle size signature of the particles in the physical medium, and
a control member configured to determine:
   by means of the first database, a first list of particle types from the current sound signature,
   by means of the second database, a second list of particle types based on the current particle size signature,
   a type of particles by intersecting the first list of particle types and the second list of particle types.

According to a preferred aspect, the second measuring member comprises an optical particle counter sensor.

According to a preferred aspect, the control member comprises a statistical classification module, preferably of the support vector or neural network type.

Preferably, the system also comprises:
a threshold database comprising a plurality of particle types, each being associated with an acceptance threshold,
said control member being configured to determine, by means of the threshold database, the acceptance threshold on the basis of the particle type determined, and to emit an alarm if the current particle size signature exceeds the acceptance threshold.

Preferably, the system also comprises:
a third database comprising a plurality of reference physical signatures, each associated with a third list of particle types, each reference physical signature being characteristic of the physical medium,
a third measuring member configured to measure a current physical signature of the physical medium,
said control member being configured to determine:
   by means of the third database, a third list of particle types based on the current physical signature,
   a type of particles by intersecting the third list of particle types.

### PRESENTATION OF FIGURES

The invention will be better understood on reading the following description, given by way of example, with reference to the following figures, given by way of non-limiting examples, in which identical references are given to similar objects.

FIG. 1 is a schematic representation of the steps in a method for the dynamic determination of a type of particle according to one embodiment of the invention.

FIG. 2 is a schematic representation of an oak panel drilling activity carried out in the vicinity of a system for the dynamic determination of the particle type according to one embodiment of the invention.

FIG. 3 is a schematic structural representation of the dynamic determination of the particle type of FIG. 2.

FIG. 4 is a schematic representation of the steps of determining the lists of particle types from the databases, and their intersection to determine the particle type according to the method shown in FIG. 1.

FIG. 5 is a schematic representation of a method for the dynamic determination of a type of particle according to another embodiment of the invention.

FIG. 6 is a schematic representation of a system for the dynamic determination of a type of particle for implementing the method shown in FIG. 5.

FIG. 7 is a schematic representation of a method for the dynamic determination of a type of particle according to another embodiment of the invention.

FIG. 8 is a schematic representation of a system for the dynamic determination of a type of particle for implementing the method shown in FIG. 7.

FIG. 9 is a schematic representation of a method for the dynamic determination of a type of particle according to another embodiment of the invention.

It should be noted that the figures set out the invention in detail in order to implement the invention, said figures of course being able to be used to better define the invention if necessary.

### DETAILED DESCRIPTION OF THE INVENTION

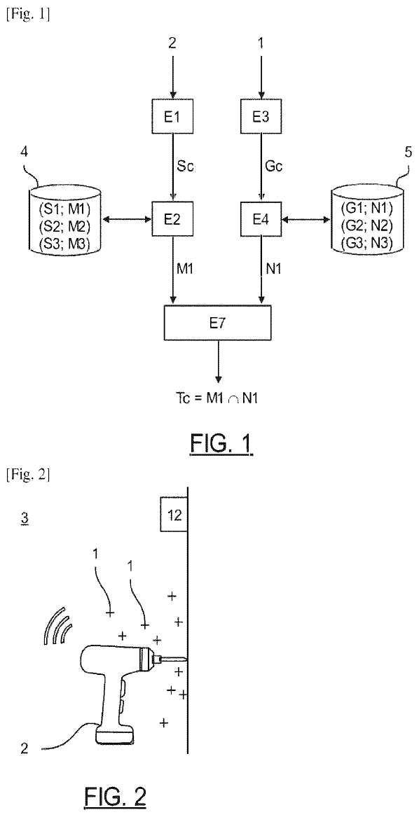

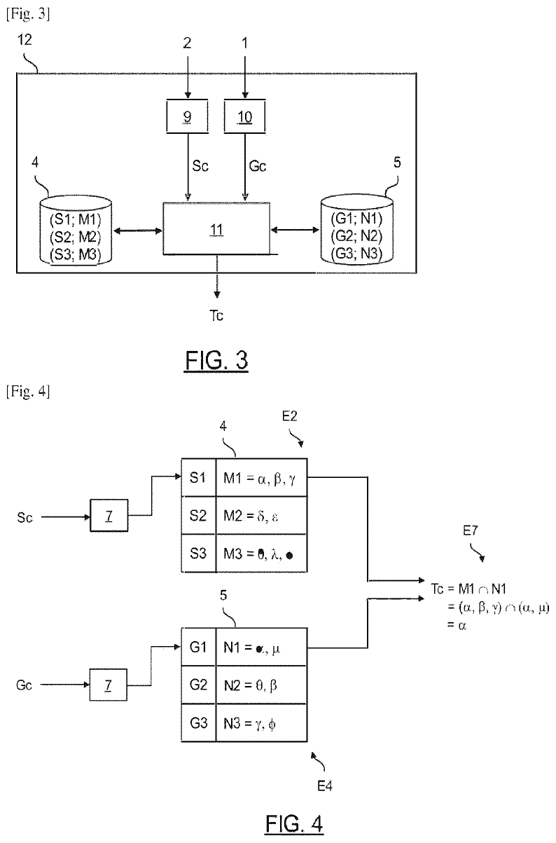

The invention relates to a method (see FIG. 1) and a system 12 (see FIG. 3) for determining one or more types Tc of particles 1 emitted into a physical medium 3 during an industrial activity 2. The invention allows a dynamic and reliable identification. In particular, the invention aims to warn an operator when one or more types of particles exceed a predetermined acceptance threshold.

As illustrated in FIG. 2, the invention is configured in particular to be implemented on the industrial production sites so as to monitor the concentration of airborne particles, referred to as aerosols, generated by the activities of the site and thus protect the health of the operators. Drilling, welding, sawdust, sanding, building demolition and road works are examples of industrial activities that emit particles such as wood, metal or glass particles when they are implemented.

Another example of the application of the invention is the quality control on the powder manufacturing sites, for example the flour milling sites. In particular, the invention allows to check the homogeneity of the powder by identification and comparison with acceptance thresholds.

Other examples of application of the invention are monitoring the concentration of suspended pollens during agricultural activities, pruning, gardening, etc. Other examples of application of the invention are monitoring the level of toxic particles in a closed environment, such as cigarette smoke or the outbreak of a fire.

Hereafter, “industrial activity” means any manual and/or automated work or action whose implementation tends to emit particles, the emission of the particles being the intended purpose of the activity (e.g., grinding flour) or an induced consequence (e.g., drilling, welding, sawdust and sanding). Hereafter, the term “particles” is used to include the particles suspended in the air, referred to as aerosols, and those present in a powder.

According to the invention, as illustrated in FIG. 1, the method is implemented by means of:
a first database 4 comprising a number of reference sound signatures S1, S2, S3, each being associated with a first list of particle types M1, M2, M3, each reference sound signature S1, S2, S3 being characteristic of one or more industrial activities 2, and
a second database 5 comprising several reference particle size signatures G1, G2, G3, each associated with a second list of particle types N1, N2, N3, each reference particle size signature being characteristic of at least one particle type 1.

Still according to the invention and as illustrated in FIG. 1, the method comprises:
a step of measuring the sound E1 of the industrial activity 2 in the physical medium 3, so as to determine a current sound signature Sc,
a step of determining E2, by means of the first database 4, a first list of particle types M1 from the current sound signature Sc,
a step of measuring the particle size E3 of the particles 1 emitted into the physical medium 3, so as to determine a current particle size signature Gc,
a step of determining E4, by means of the second database 5, a second list of particle types N1 from the current particle size signature Gc, and
a step of determining E7 the type or types Tc of particles 1 by intersection of the first list of particle types M1 and the second list of particle types N1.

As illustrated in FIG. 2, the method is implemented in the physical medium 3 of the particles 1, close to the industrial activity 2. The system 12 is configured to implement the method during the industrial activity 2 and is fixedly installed in the physical medium 3 in the vicinity of the industrial activity 2. In other embodiments, the system 12 is portable, in particular configured to be carried by an operator. This allows reliable and relevant sound and particle size measurements to be taken to identify the industrial activity and the suspended particles. Preferably, the system 12 has a battery so that it is autonomous.

With reference to FIG. 3, the system 12 comprises, in addition to the first database 4 and the second database 5 previously described:
a first measuring member 9 configured to measure a current sound signature Sc of the industrial activity 2 in the physical medium 3,
a second measuring member 10 configured to measure a current particle size signature Gc of the particles 1 in the physical medium 3, and
a control member 11 configured to determine:
   by means of the first database 4, a first list of particle types M1 based on the current sound signature Sc,
   by means of the second database 5, a second list of particle types N1 based on the current particle size signature Gc,
   a type Tc of particle 1 by intersecting the particle type lists M1, N1.

Each step of the method is described in more detail below, using the example of drilling an oak panel.

With reference to FIGS. 1 and 3, the sound measuring step E1 is implemented by the first measurement member 9 during the industrial activity 2. The sound measuring step E1 is used to determine a current sound signature Se for the industrial activity 2. The first measuring member 9 is preferably in the form of a microphone configured to record the sound emitted when the industrial activity 2 is implemented.

Preferably, the current sound signature Sc is determined from at least one temporal sound recording to be representative of the industrial activity 2. Preferably, the current sound signature Sc is determined from a Fourier transformation of the temporal sound recording. Such a sound signature may be conveniently compared with the sound signatures S1, S2, S3 in the first database 4.

With reference to FIGS. 1 and 4, the step E2 of determining a first list of particles M1 is implemented after the step E1 of measuring the current sound signature Se. The first list of particle types M1 is selected in the first database 4 from the assembly of lists of particle types M1, M2, M3. The first list of particles M1 chosen corresponds to the one whose reference sound signature S1, S2, S3 is closest to the current sound signature Se.

With reference to FIG. 4, this example assumes that the first database 4 is as follows:
S1 is a reference sound signature of a drilling activity associated with a first list of particles M1 comprising the oak α, the chipboard β and the plastic γ.
S2 is a reference sound signature of a welding activity associated with a first list of particles M2 comprising aluminum δ and titanium ε.

S3 is a reference sound signature of a milling activity associated with a first list of particles M3 comprising T45 flour θ, T55 flour λ and T65 flour φ.

It should be noted that the size of the databases 4, 5, 6, 8 used in the invention, restricted in the example presented here, is preferably extended and depends in practice on the field of application.

As illustrated in FIGS. 1, 3 and 4, the determining step E2 is implemented by the control member 11, and preferably by a statistical classification module 7 of the control member 11. The statistical classification module 7, of the neural network or support vector type, is configured to compare the current sound signature Sc with the reference sound signatures S1, S2, S3 in the first database 4 and to determine which is the closest, S1 in this example. The control member 11 is then configured to select the first list of particles M1 associated with the chosen reference sound signature S1, namely the oak a, the chipboard β and the plastic γ in this example. Preferably, the control member 11 is in the form of a computer or similar.

Preferably, each reference sound signature S1, S2, S3 comprises at least one frequency characteristic of the industrial activity 2 with which it is associated. Preferably, each reference sound signature S1, S2, S3 comprises a sound spectrum characteristic of the industrial activity. In the determining step E2, the statistical classification module 7 compares the sound spectrum of the current sound signature Sc with the sound spectra of the reference sound signatures S1, S2, S3. The reference sound signature S1 chosen is the one whose characteristic sound spectrum is the least distant from that of the current sound signature Sc.

Preferably, the method comprises a preliminary training step E0 of the statistical classification module 7 on the basis of training sound signatures Sc.

As illustrated in FIG. 1, the steps of particle size measurement E3 and determination E4 of a second list of particle types M2 are implemented independently of the steps of sound measurement E1 and determination E2 of the first list of particle types M1, preferably in parallel for a faster method.

With reference to FIGS. 1 and 3, the particle size measuring step E3 is implemented by the second measuring member 10, which preferably comprises an optical particle counter sensor. During the particle size measuring step E3, the optical particle counter sensor is configured to measure a current particle size signature Ge of the particles 1 in the physical medium 3, in this example, the aerosols emitted by the drilling of the oak panel. Such a particle size signature Ge comprises a concentration and a histogram of the size distribution of the aerosols measured in the physical medium 3. The measurement by means of an optical particle counter sensor is known per se to the person skilled in the art and is therefore not described further.

With reference to FIGS. 1 and 3, the step E4 of determining a second list of particles N1 is implemented after the step E3 of measuring the current particle size signature Gc. The second list of particle types N1 is selected from the second database 5 from the assembly of lists of particle types N1, N2, N3. The second list of particles N1 chosen corresponds to those whose reference particle size signature G1, G2, G3 is closest to the current particle size signature Gc.

As shown in FIG. 4, the second database 5 is assumed to be as follows:
G1 is a reference particle size signature associated with a second list of particles N1 comprising oak a and glass μ.
G2 is a reference particle size signature associated with a second list of particles N2 comprising T45 flour θ and agglomerate β.
G3 is a reference particle size signature associated with a second list of particles N3 comprising plastic γ and T65 flour φ.

As illustrated in FIGS. 1, 3 and 4, the determination step E4 is implemented by the control member 11, and preferably by the statistical classification module 7. The statistical classification module 7 is configured to compare the histogram of the current particle size signature Gc with that of the reference particle size signatures G1, G2, G3 in the second database 5 and to determine which is the closest, G1 in this example. The control member 11 is then configured to select the second list of particles N1 associated with the closest reference sound signature G1, namely the oak a and the glass μ in this example.

With reference to FIGS. 1, 3 and 4, the step E7 of determining the type of particles Tc is implemented after the steps E2, E4 of determining the lists of particle types M1, N1. In the determination step E7, the control member 11 performs an intersection operation between the first list of particle types M1 and the second list of particle types N1:Tc=M1 ∩N1. In other words, the particle type Tc determined by the control member 11 corresponds to the elements common to the first and second lists of particle types M1, N1, in this example the oak α.

In this way, the type of particles Tc is determined using two different measurements to allow a reliable and relevant identification. Advantageously, the combination of a sound signature and a particle size signature forms an assembly that discriminates the type of particles Tc. Two different types of particle with similar particle size signatures may be distinguished by their sound signature, and vice versa.

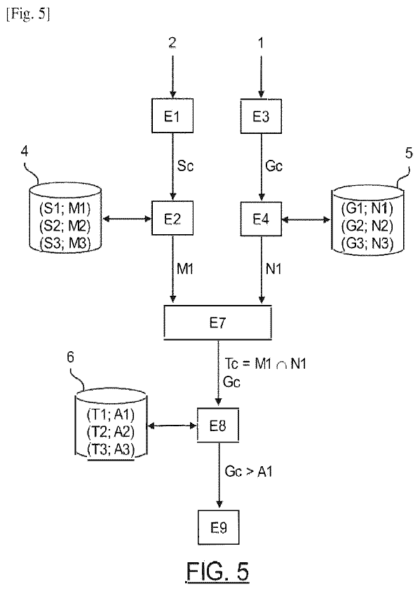

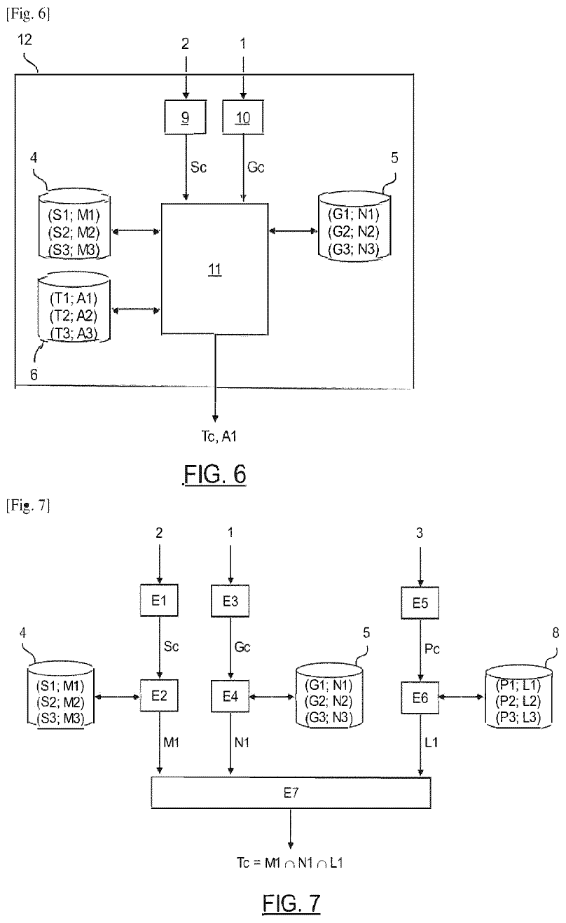

According to a preferred aspect of the invention illustrated in FIGS. 5 and 6, the method is also implemented by means of a threshold database 6 comprising several types T1, T2, T3 of particles 1, each associated with an acceptance threshold A1, A2, A3.

As illustrated in FIG. 5, the method comprises a determination step E8, wherein the control member 11 determines, by means of the threshold database 6, the acceptance threshold A1 associated with the type Tc of particles 1 determined, in this example the oak. The acceptance threshold A1 corresponds to the maximum concentration of airborne oak particles permitted to safeguard the health of the operator carrying out the drilling operation on the oak α panel.

As illustrated in FIG. 5, after the implementation of the determination step E8, the method comprises a step of emitting an alarm E9 if the current particle size signature Gc exceeds the acceptance threshold A1. The emission step E9 allows to warn the operator of a potential excess, for example by means of an audible, computerized or visual signal.

Alternatively, the acceptance threshold corresponds to the maximum permitted level of heterogeneity between the particles of the powder to be identified, for example the T55 flour. The emission step E9 then allows to warn the operator that the quality of the powder is insufficient.

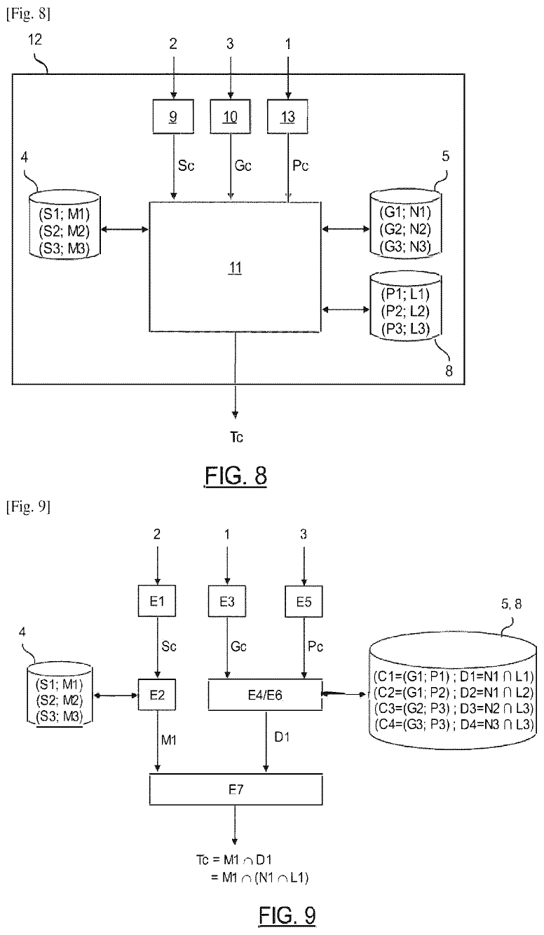

According to a preferred aspect of the invention illustrated in FIGS. 7 and 8, the method is also implemented by means of a third database 8 comprising a plurality of reference physical signatures P1, P2, P3, each being associated with a third list of particle types L1, L2, L3, each reference physical signature P1, P2, P3 being characteristic of the physical medium 3.

As illustrated in FIG. 7, the method comprises:
a step E5 of measuring a current physical signature Pc of the physical medium 3,
a step E6 of determining, by means of the third database 8, a third list of particle types L1 from the current physical signature Pc,
the determination step E7 also being implemented by intersection with the third list of particle types L1.

According to a preferred aspect of the invention, the current physical signature Pc comprises a measurement of the temperature, humidity and/or odor of the physical medium 3, namely the surrounding air in the example of an oak panel drilling activity. The type of particles Tc is advantageously determined by means of three different measurements to allow a more reliable and relevant identification. Such a current physical signature increases the discriminating character of the assembly formed by the sound signature and the particle size signature.

As illustrated in FIG. 7, the measurement step E8 and determination step E9 are implemented independently of the sound measurement step E1, particle size measurement step E3 and determination step E2, E4 of the other lists of particle types M1, N1, preferably in parallel for a faster method.

With reference to FIGS. 7 and 8, the measurement step E8 is implemented by a third measurement member 10, such as a temperature sensor, a humidity sensor, an electrochemical sensor or a metal oxide sensor (MOX sensor). The step E9 of determining a third list of particles L1 is implemented after the measurement step E8. The third list of particles L1 chosen corresponds to the one whose reference physical signature P1, P2, P3 is closest to the current physical signature Pc, i.e., P1 in this example. The determination step E4 is implemented by the control member 11, preferably by the statistical classification module 7.

With reference to FIGS. 7 and 8, in the determination step E7, the control member 11 performs an intersection operation between the first list of particle types M1, the second list of particle types and the third list of particle types L1:Tc=M1∩N1∩L1.

According to a preferred embodiment of the invention illustrated in FIG. 9, the second database 5 and the third database 8 are combined together and comprise several combinations of reference activities C1-C4. Each reference activity combination C1-C4:
comprises a reference sound signature S1, S2, S3 and a reference physical signature P1, P2, P3,
is associated with a combined list of particle types D1-D4.

Each combined list of particle types D1-D4 is the intersection of a second list of particle types N1, N2, N3 and a third list of particle types L1, L2, L3, namely those associated with the reference sound signature S1, S2, S3 and the reference physical signature P1, P2, P3. As an example, the reference activity combination C2=(S1; P2) is associated with a combined list of particle types D2=N1∩L2. The reference physical signature P1, P2, P3 is thus an auxiliary measure of the reference sound signature S1, S2, S3, which allows to determine the industrial activity 2 implemented accurately and reliably. It may also be possible to mount an electronic chip, for example of the NFC or Bluetooth type, on the systems used to implement the industrial activity, such as a saw or a drill, and to determine the industrial activity being implemented by reading the electronic chips located in the vicinity.

With reference to FIG. 9, the determination step E4 and the determination step E6 form one and the same step, implemented after the measurement steps E3 and E5, wherein a combined list of particle types D1-D4 is determined from the current sound signature Sc and the current physical signature Pc. More specifically, the statistical processing module 7 determines the reference activity combination C1-C4 closest to the current sound signature Sc and the current physical signature Pc. The control member 11 then selects the associated combined list of particle types D1-D4, which is used for the step of determining E7 the type Tc of particle 1.

1-10. (canceled)

11. A method for dynamically determining at least one type of particles, the particles being emitted during the implementation of an industrial activity in a physical medium, said method being implemented by means of at least:
a first database comprising a plurality of reference sound signatures, each being associated with a first list of particle types, each reference sound signature being characteristic of at least one industrial activity, and
a second database comprising a plurality of reference particle size signatures, each being associated with a second list of particle types, each reference particle size signature being characteristic of at least one particle type,
said method comprising:
a step of measuring the sound of the industrial activity in the physical medium, so as to determine a current sound signature,
a step of determining, by means of the first database, a first list of particle types from the current sound signature,
a step of measuring the particle size of the particles emitted into the physical medium, so as to determine a current particle size signature,
a step of determining, by means of the second database, a second list of particle types from the current particle size signature,
a step of determining at least one type of particles by intersecting the first list of particle types and the second list of particle types.

12. The method according to claim 11, said method also being implemented by means of a threshold database comprising a plurality of types of particles, each being associated with an acceptance threshold, said method comprising:
a step of determining, by means of the threshold database, an acceptance threshold on the basis of the type of particles determined, and
a step of emitting an alarm if the current particle size signature exceeds the acceptance threshold.

13. The method according to claim 11, wherein each reference sound signature of the first database comprises at least one frequency characteristic of the associated industrial activity.

14. The method according to claim 11, wherein each reference sound signature of the first database comprises a sound spectrum characteristic of the associated industrial activity.

15. The method according to claim 11, wherein the particle size measurement step is implemented by means of an optical particle counter.

16. The method according to claim 11, wherein the determination step is implemented by determining, from among the reference sound signatures of the first database, which is closest to the current sound signature.

17. The method according to claim 11, wherein the determination step is implemented by means of a statistical classification module.

18. The method according to claim 17, wherein the statistical classification module is of the support vector or neural network type.

19. The method according to claim 17, also comprising a preliminary step of training the statistical classification module from a plurality of training sound signatures, the statistical classification module being configured to determine the closest reference sound signature in the first database.

20. The method according to claim 11, said method also being implemented by means of a third database comprising a plurality of reference physical signatures, each being associated with a third list of particle types, each reference physical signature being characteristic of the physical medium, said method comprising:
a step of measuring a current physical signature of the physical medium,
a step of determining, by means of the third database, a third list of particle types from the current physical signature,
the determination step being further implemented by intersection with the third list of particle types.

21. The method as claimed in claim 20, wherein the current physical signature comprises one or more of the following elements: a temperature measurement, a humidity measurement and an odor measurement of the physical medium.

22. A system for dynamically determining at least one type of particles for implementing the method according to claim 1, the particles being emitted during the implementation of an industrial activity in a physical medium, said system comprising at least:
a first database comprising a plurality of reference sound signatures, each being associated with a first list of particle types, each reference sound signature being characteristic of at least one industrial activity, and
a second database comprising a plurality of reference particle size signatures, each being associated with a second list of particle types, each reference particle size signature being characteristic of at least one particle type,
a first measuring member configured to measure a current sound signature of the industrial activity in the physical medium,
a second measuring member configured to measure a current particle size signature of the particles in the physical medium, and
a control member configured to determine:
by means of the first database, a first list of particle types from the current sound signature,
by means of the second database, a second list of particle types based on the current particle size signature,
a type of particle by intersecting the first list of particle types and the second list of particle types.
